(19) United States
(12) Patent Application Publication
(10) Pub. No.: US 2026/0267731 A1
(43) Pub. Date: Sep. 10, 2026

(54) TECHNIQUES FOR MAINTAINING A CLIENT DEVICE

(71) Applicant: Absolute Software Corporation, Vancouver (CA)

(72) Inventor: Adam Vincent PICCONE, Denver, CO (US)

(21) Appl. No.: 19/544,196

(22) Filed: Feb. 19, 2026

Related U.S. Application Data
(60) Provisional application No. 63/760,315, filed on Feb. 19, 2025.

(51) Int. Cl. G06F 11/07

(52) U.S. Cl. CPC G06F 11/0793; G06F 11/079

(57) ABSTRACT

There is disclosed a method for maintaining a client device. The method comprises monitoring, by an application monitoring engine, application health data of applications installed on the client device, the application health data defining at least one application property for each of the installed applications; detecting, by a predictive maintenance engine, a predetermined condition from the at least one application property based on monitor rules; in response to the detecting of the predetermined condition, generating a predictive maintenance action.

### FIELD OF THE INVENTION

This application relates to maintaining applications on a computing device. In particular, the application relates to the predictive maintenance of applications installed on a client device.

### BACKGROUND OF THE INVENTION

Organizations may desire to maintain the compliance and protection of their device fleet against ever-increasing cyber threats in today’s digital environment. Despite this, applications may be tampered with through the reimaging of machines, disabling of running services by negligent users or malicious intruders and the corruption of registry files. This vulnerability at the endpoint application layer can leave organizations susceptible to cyber threats, fleet non-compliance and ultimately large financial penalties. Further, applications may not be running optimally for reasons.

An administrator has the ability to actively monitor application compliance at the fleet level. However, the ability to monitor application compliance potentially requires manual annotation of data for every version of the application, including the services being run (or disabled), the registry files and operational files, directories where files are stored, etc.

There exists a need for improved or alternative methods for maintaining compliance of a device’s applications. In particular, there is a need to predict the compliance of an application without the requirements of manual annotation of all of the properties of the application.

### SUMMARY OF THE INVENTION

In an aspect, there is provided a method for maintaining a client device. The method comprises: monitoring, by an application monitoring engine, application health data of applications installed on the client device, the application health data defining at least one application property for each of the installed applications; detecting, by a predictive maintenance engine, a predetermined condition from the at least one application property based on monitor rules; in response to the detecting of the predetermined condition, generating a predictive maintenance action.

In some embodiments, the predictive maintenance engine is run on a server remote from the client device.

In some embodiments, the predictive maintenance engine is run by the client device.

In some embodiments, the monitor rules are received from a server.

In some embodiments, the method further comprises receiving, from the server, updated monitor rules for detecting the predetermined condition, the updated monitor rules generated based on the log data.

In some embodiments, the method further comprises: detecting an anomaly associated with an operation of one of the installed applications; and sending an anomaly report to the server, the anomaly report comprising the at least one application property of the anomalous application. In some preferred embodiments, the method further comprises: receiving, from the server, updated monitor rules for detecting the predetermined condition based on the anomaly report.

In some embodiments, the at least one application property comprises: application install date; application version; application installation path; application executable file size; resource usage data; application registry information; active processes; or a combination thereof. In some embodiments, the at least one application property comprises: application install date; application version; application installation path; and application executable file size.

In some embodiments, the monitor rules comprise determining, for each of the installed applications: an application relative install date score; an application version health score; an application installation path score; an average age of all of the installed applications on the client device score; a total number of the installed applications on the client device score; an application executable file size score; or a combination thereof.

In an aspect, there is provided a client device comprising: a processor, and a memory comprising: at least one application installed on the client device, and executable instructions stored thereon. When executed, the instructions cause the device to: monitor application health data of the at least one application, the application health data defining at least one application property for each of the at least one application; detect a predetermined condition using at least one application property for each of the at least one application based on monitor rules; and in response to the detection of the predetermined condition, generate a predictive maintenance recommendation.

In an aspect, there is provided a system for predictively maintaining a client device. The system comprises: a client device and a server in communication with the client device. The client device comprises: a processor; and a memory comprising: at least one application installed on the client device; executable instructions stored thereon, that when executed cause the device to: monitor application health data of the at least one application, the application health data defining at least one application property for each of the at least one application; and transmit the application health data in response. The server comprises: a processor; and a memory comprising: executable instructions stored thereon, that when executed cause the server to: receive application health data of the at least one application from the client device; detect a predetermined condition using the at least one application property for each of the at least one application based on monitor rules; and generate a predictive maintenance recommendation describing the predetermined condition and one or more actions.

### BRIEF DESCRIPTION OF THE DRAWINGS

The features of the invention will become more apparent in the following detailed description in which reference is made to the appended drawings wherein:

FIG. 1 a schematic diagram illustrating an example of a software configuration of a predictive maintenance system according to an embodiment;

FIG. 2 is schematic diagram illustrating a system for predictively maintaining a client device according to an embodiment;

FIG. 3 is a flow diagram illustrating a method of maintaining a client device according to an embodiment; and

FIG. 4 is a chart illustrating the accuracy of a prediction of compliance of applications installed on a client device according to an embodiment;

FIG. 5 is a chart showing the calculation of a compliance score according to an embodiment; and

FIG. 6 is a schematic diagram illustrating an example of a software configuration of a predictive maintenance system according to another embodiment.

### DETAILED DESCRIPTION OF THE INVENTION

In the following detailed description, numerous embodiments and details are described to provide a thorough understanding of the invention. However, these embodiments may be modified and details omitted without necessarily departing from the scope of the invention herein. In other instances, well-known methods, procedures, components and systems have not been described in detail so as not to obscure the presently disclosed subject matter.

As used herein, the phrase “for example,” “such as”, “for instance”, “including”, and “comprising” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

As used herein, a “client device”, “user device” or a “computing device” may be used interchangeably and refers to any general-purpose computing device having applications installed thereon. Examples of client devices include computers, workstations, thin-clients, mobile computers, mobile phones, and tablet computers.

As used herein, “health” refers to a likelihood that an application has a tolerably low likelihood of bugs, errors, security vulnerabilities, compatibility issues, and other issues that may affect the operation of a user device, including with respect to the applications installed thereon. Other health issues arise when an application simply does not run on a device, or an application requires specific services that are not started or running on the device.

Unless specifically stated otherwise, features described in separate embodiments can be combined into a single embodiment. Conversely, features described in the context of a single embodiment can be provided separately or in any suitable sub-combination in other embodiments.

The disclosure relates to determining or predicting the health of applications installed on a user device. This determination or prediction can, for example, be used to improve the functioning of the user device by identifying whether service or maintenance actions should be performed.

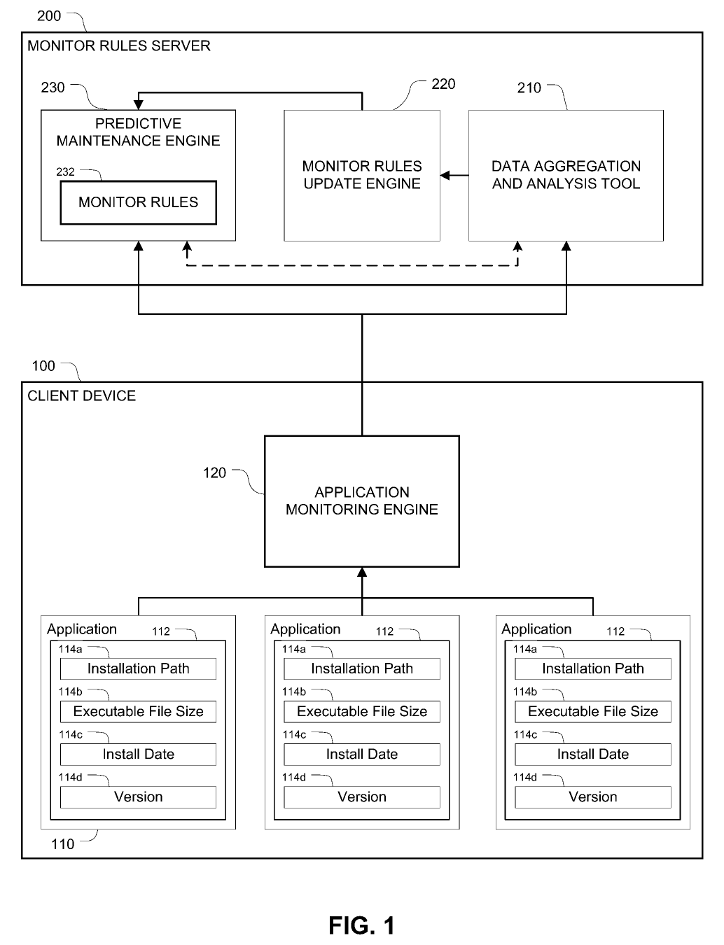

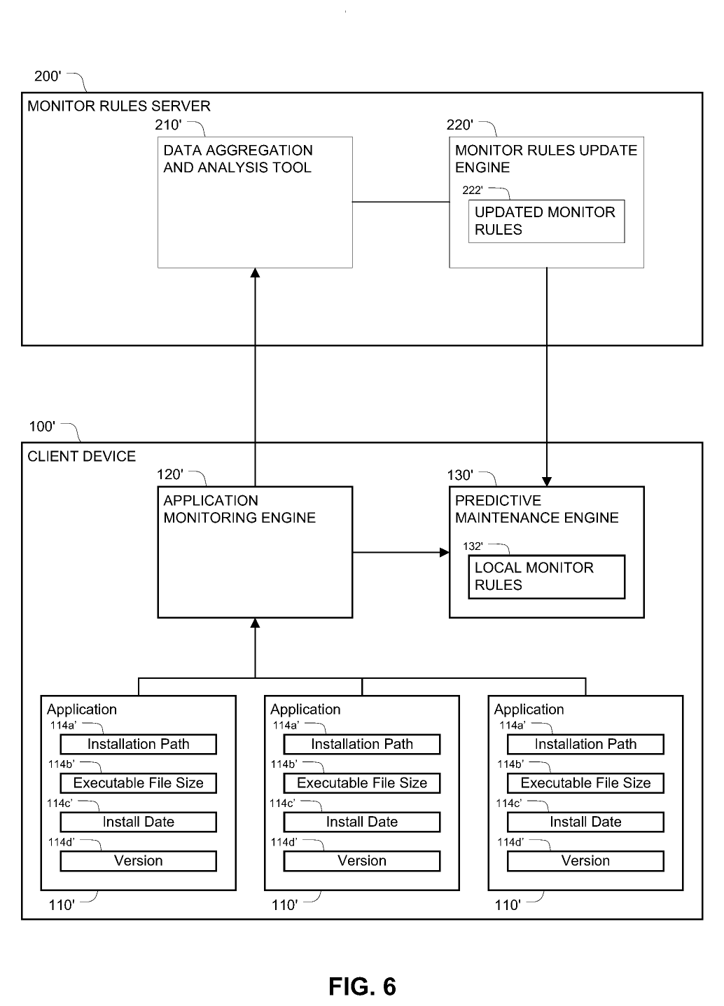

FIG. 1 is a schematic diagram illustrating an example of a software configuration of a predictive maintenance system according to an embodiment. A client device 100 has one or more application 110 installed thereon. An application monitoring engine 120 installed on client device 100 will periodically poll applications 110 to determine application health data 112 for each application. The application health data 112 includes application properties 114, which can include, but is not limited to, installation path 114a (sometimes referred to as “Application EXE path”), total executables file size 114b, installation date 114c and version 114d. The application monitoring engine 120 assembles the application health data 112 of each application 110 into a log 116 and provides the log 116 to a predictive maintenance engine 230 of a monitor rules server 200. In some embodiments, the predictive maintenance engine is run on the client device 100 instead of, or in addition to, the server 200 (see, for example, FIG. 6).

The predictive maintenance engine 230 determines whether a predetermined condition is met based on monitor rules 232. In some embodiments, the predictive maintenance engine 230 determines additional application properties 114 that may be required for detection of a predetermined condition based on the monitor rules 232, such as by using the application properties 114 received from the application monitoring engine 120. In some embodiments, the predictive maintenance engine 230 may determine an average age 114e of all applications 110 installed on the client device 100 and a count 114f of all applications 110 installed on the client device 100 using information sent by application monitoring engine 120. Where a predetermined condition is met, the predictive maintenance engine 230 may initiate a further action, such as providing a notification to a network administrator, or initiating corrective action, such as triggering a reinstallation of an unhealthy application 110.

The monitor rules server 200 receives logs 116 from at least one client device 100, such as a fleet of client devices. A data aggregation and analysis engine 210 aggregates the logs 116 and analyzes them to generate or refine monitor rules. For example, aggregated data may be used in unsupervised machine learning (e.g. cluster analyses, neural networks) or supervised machine learning (e.g. gradient boosting, logistic regression and random forests) to determine or optimize monitor rules. In some embodiments, logs 116 include annotated application health information. In some embodiments, logs 116 are sent upon an error reporting event, such as during a crash of the application or a service request by a user. In some embodiments, the data aggregation and analysis engine 210 cross-references data from logs 116 against information from predictive maintenance engine 230.

The aggregation and analysis engine 210 provides results of the analysis to the monitor rules update engine 220, which generates updates to monitor rules 232. In some embodiments, where the predictive maintenance engine is run locally, the predictive maintenance engine polls the monitor rules update engine to determine whether updated monitor rules are available, or the monitor rules update engine pushes updated monitor rules to the predictive maintenance engine.

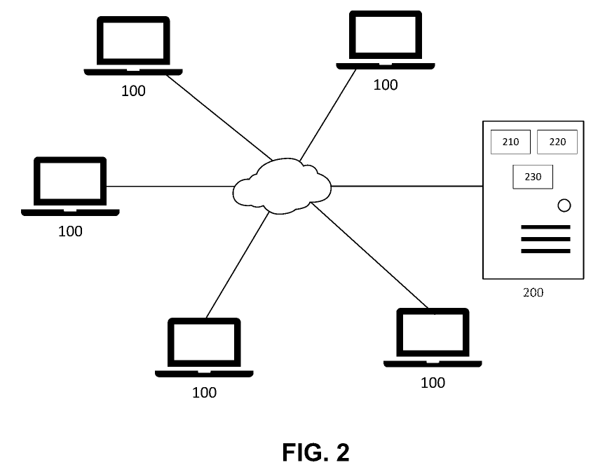

FIG. 2 is an example of an environment in which the applications are maintained across a fleet of client devices 100. Each client device 100 with applications 110 installed thereon are connected to the monitor rules server 200, such via a network. These client devices 100 provide logs 116 with data about applications installed thereon to server 200.

The server 200 includes a predictive maintenance engine 230 and optionally a data aggregation and analysis tool 210 and a monitor rules update engine 220. The predictive maintenance engine 230 receives application health data 112 from the fleet of client devices to detect for a predetermined condition. The optional data aggregation and analysis tool 210 processes logs 116 from the fleet of client devices which is used by the monitor rules update engine 220 to update monitor rules used by predictive maintenance engine 232 to detect predetermined conditions. The system may include a data store for storing monitor rules 232, which may be retrieved by the predictive maintenance engine. In other embodiments, logs are assembled from a fleet of client devices and are analyzed to determine monitor rules, which are used offline by the client device 100’. In these embodiments, logs need not be sent to a server by the client device via a network, and local monitor rules on a client device are not necessarily updated via a network.

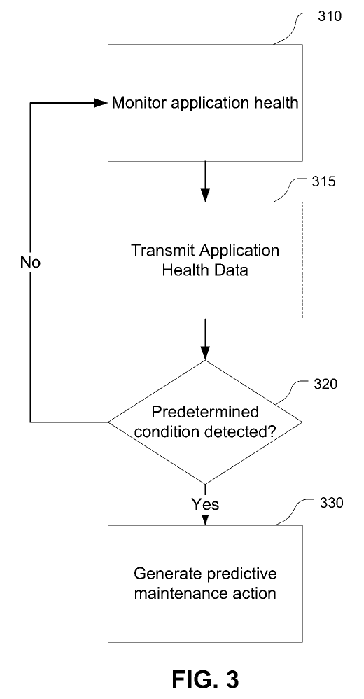

Having reference now to FIG. 3, there is provided according to an aspect, a method 300 for maintaining a client device. The method includes, at block 310, monitoring application health data of applications installed on the client device. The application health data defines at least one application property for each of the installed applications. In some embodiments, the at least one application property includes application install date; application version; application installation path; application executable file size; resource usage data; application registry information; active processes; or a combination thereof. In some embodiments, the at least one application property includes application install date; application version; application installation path; and application executable file size. In some embodiments, the monitoring is performed by an application monitoring engine on the client device. In some embodiments, the monitoring is performed continuously, discretely, or a combination thereof. For example, an application monitoring engine 120 may be gathering application health data 112 for applications 110 running on client device 100 on a set schedule, such as every morning.

At block 320, the method detects for a predetermined condition from the at least one application property based on monitor rules. In some embodiments, the predetermined condition indicates that an application installed on the client device is unhealthy. In some embodiments, the monitor rules provide a calculation for a compliance score based on the at least one application property. In some embodiments, the predetermined condition is a compliance score below a threshold value. In some embodiments, the compliance score is between 0 and 1, and the threshold value is 0.5. In some embodiments, the detecting is performed by a predictive maintenance engine on a server using application health data from the client device, such as, without limitation, logs received from an application monitoring engine run on the client device. In some embodiments, the predictive maintenance engine is on the client device. In some embodiments, the predictive maintenance engine generates additional application properties from the application data received from the application monitoring engine, for example, based on aggregated application data from a plurality of applications.

In some embodiments, for each of the installed applications, the detection of the predetermined condition includes determining an application relative install date score; an application version health score; an application installation path score; an average age of all of the installed applications on the client device score; a total number of the installed applications on the client device score; an application executable file size score; or a combination thereof. In some embodiments, these are z-scores generated based on the monitor rules. For example, the monitor rules may include frequencies for versions, executable file sizes, installation paths, and relative scoring coefficients for install date, average age of installed applications, and total number of installed applications.

In response to the detection of the predetermined condition, the method at block 330 generates a predictive maintenance action. In some embodiments, the predictive maintenance action is a notification sent to a server. In some embodiments, the predictive maintenance action is generated by the server. The notification may be used, for example, by an administrator to initiate maintenance on the client device, such as by reinstalling or updating the affected application remotely, or by requesting that a user bring in the client device for service. In some embodiments, the notifications from each client device are aggregated to prioritize the client devices that need to be serviced. For example, the server may include a list of client devices with notifications of unhealthy applications installed thereon, and prioritization of the service of the client devices based on the number of unhealthy applications installed thereon. In some embodiments, the applications installed thereon are weighted, and the prioritization of service is based on a weighted number of unhealthy applications. In some embodiments, the weighting is based on importance of the application for the user of the client device or for its role in the operations of the company who maintains a fleet of client devices. In some embodiments, an unhealthy application is automatically reinstalled or updated on the client device without the need for user action.

In some embodiments, the method optionally comprises receiving the monitor rules. In some embodiments, the receipt of the monitor rules occurs before the detection of the predetermined condition, after the detection of the predetermined condition or both. For example, in embodiments where the predictive maintenance engine runs on a client device, the client device may receive updated monitor rules periodically from a server (see, for example, FIG. 6). In some embodiments, the client device requests the monitor rules updates. In other embodiments, the server pushes the monitor rules updates to the client device.

In some embodiments, log data comprising the application health data of the installed applications is sent to the server at block 315. In some embodiments, the log data is sent upon the installation or modification of the application, as after the completion of an update to an application. In some embodiments, updated monitor rules for detecting the predetermined condition are received from the server, the updated monitor rules being generated based on the log data.

In some embodiments, the method detects an anomaly associated with an operation of one of the installed applications, and an anomaly report is sent to the server. The anomaly report includes the at least one application property of the anomalous operation, and the anomaly is associated with the predetermined condition. For example, if an application crashes, a report of the crash may be sent to the server along with the at least one application property. With this information, the server may update the monitor rules with additional data of a predetermined condition, such an unhealthy application. In some embodiments, the updated monitor rules are generated by the server using data from the anomaly report and the method includes receiving updated monitor rules. In other embodiments, the predictive maintenance engine accesses updated monitor rules maintained by the monitor rules update engine when detecting for predetermined conditions.

In another aspect, there is provided a client device. The client device includes a processor and a memory. The memory has applications installed on the client device, and executable instructions stored thereon. The executable instructions, when executed, cause the device to monitor application health data of the applications, the application health data defining at least one application property for each of the applications; detect a predetermined condition based on monitor rules; and in response to the detection of the predetermined condition, generate a predictive maintenance recommendation.

In yet another aspect, there is provided a system for enabling predictive maintenance of a client device. The system includes a client device and a server in communication with the client device. The client device includes a processor and a memory. The memory has applications installed on the client device, and executable instructions stored thereon. The executable instructions, when executed, cause the device to monitor application health data of the applications, the application health data defining at least one application property for each of the applications; detect a predetermined condition based on monitor rules; and in response to the detection of the predetermined condition, generate a predictive maintenance recommendation. The server is configured to receive the application health data, transmit the monitor rules to the client device.

### Example

Data (e.g. the application health data) was obtained from logs of approximately 40,000 client devices having at least one of five applications installed thereon. The health of the five applications of each install on the client devices was known. The data was divided into two portions to create a “truth set” and a “test set”.

The “truth set” was analysed using statistical techniques to identify application properties most predictive of application health and determine their effects. For example, different types of data were converted into z-scores and a logistic regression was performed on the various types of data to determine the application properties and the coefficients applicable thereto in a general model. This application properties tested included: version of the application, the average age of all applications installed on the client device, the number of applications installed on the client device, the installation path of the application, the relative age of the application, the application executables total file size; the application language; the application product codes; the application’s publisher; the application’s uninstallation registry key; the application’s name.

From logistic regression, it was determined that the factors most predictive of an application’s health were: (1) version of the application, (2) the average age of all applications installed on the client device, (3) the number of applications installed on the client device, (4) the installation path of the application, (5) the relative age of the application, and (6) the application executables total file size (e.g. collectively, the application health properties). Without being bound by theory, it is believed that the factors contribute to the predictive value of the health of an application as follows.

With regards to the version of the application, it was determined that the higher the frequency that a version was installed on a client device, the higher the likelihood it was a healthy application. With older versions of an application, even though it may be stable, vulnerabilities may be uncovered, and newer features may be released, creating a desire or need for a newer version of an application to be installed. However, while newer versions of applications may contain bug fixes or vulnerability patches, they may also introduce new bugs or vulnerabilities if new features are added. Accordingly, the newest versions of software may be rolled back to an older version, skipped or not installed until admins or other users are able to test and verify the desirability of the new version. Across a fleet of devices, this results in the common version of applications being associated with healthy versions.

With regards to the average age of all applications installed on the client device, this tends to indicate of the age of the client device, since many applications are installed when the client device is first set up, and how well it is maintained, as applications are updated, such as with bug fixes and security patches, tend to reduce the age of the applications installed on the client device. As client devices age, they may become underpowered relative to more recent devices or performance degradation (for example, from thermal issues associated with dust accumulation or thermal compound degradation, wear and tear on components, increased likelihood of drops and other physical damage due to handling, etc.). Older client devices may not be compatible with newer applications because the system does not meet the system requirements to run the applications.

With regards to the number of applications installed on the client device, the greater the number of applications, the greater the likelihood that a client device becomes unstable. For example, this can increase the likelihood that applications that compete for resources or are running services that interfere with each other, such as in the case with multiple antivirus software.

With regards to the installation path of the application, installations in the default location tended to decrease the likelihood that an update or an add-on component would be problematic. For example, if updates or add-ons were hardcoded to look for files in a certain location, there may be errors if the application were actually installed in a different location. The default location tends to be the most frequently found installation path, and was generally associated with a higher likelihood of a healthy application. Depending on the device, there may one or more data sources from where the installation path may be obtained, such as registry keys in Windows™ operating systems, using the “which” or “whereis” command in different flavors of Linux. For example, the installation path of a single application may found independently in multiple registry keys. In preferred embodiments, the installation path is obtained from a data source that is consistently populated for all applications installed on a device, such as the uninstall key in Windows™ operating systems.

With regards to the relative age of the application, this factor compares the date of the application with the average age of all applications installed on the client device. Where an application has been installed on the client device for a relatively long period of time, this can indicate that it has not been updated. As vulnerabilities and bugs are discovered in applications, this can mean that the application will become unhealthy if not updated.

With respect to the total executables file size, this can indicate whether the executable is one that is expected. In some embodiments, the total executables file size is compared to the application version. This comparison may detect instances where executables have been altered or corrupted. For example, where an application has an executable that is 0 bytes, the application is likely to be corrupted and not functioning properly. In some embodiments, where an application version has an executable file size that does not match that of what is typically encountered, there may be an increased likelihood that the executable has been altered or tampered with. In some embodiments, a checksum can be used to verify the integrity of the executables.

The model (e.g. monitor rules) can generate a predicted compliance score indicating the likelihood that the application was healthy for each application using the factors (e.g. application properties) above. The model was then used to on the “test set” to evaluate the accuracy of predictions of an application’s health.

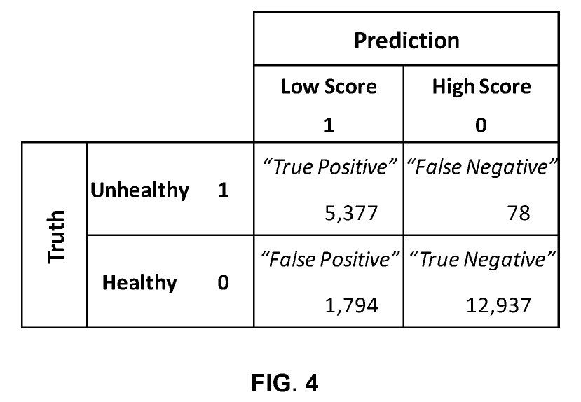

Having reference to FIG. 4, using the “test set” mentioned above, predictions of application health (e.g. by a predictive health engine) were generated for 20,186 applications of known health. Predicted compliance scores between 0 and 1 were rounded to either 0 or 1. The model was able to correctly predict that an application was unhealthy in 98.6% of cases. Additionally, the false negative rate was 1.4% (where an application was predicted to be healthy but was actually unhealthy) while the false positive rate was 12% (where an application was predicted to be unhealthy but was actually healthy). While, ideally, both types of false hit rates are extremely low, it is more tolerable to have a higher false positive rate than a false negative rate. This is because false negative rates may cause an administrator to miss potentially problematic application health issues.

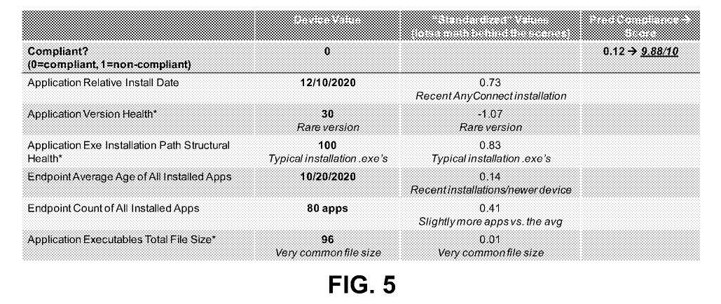

Having reference to FIG. 5, a sample score was calculated for one application installed on a client device. This was a healthy installation of the application, despite a relatively rare version of the application being installed. The health of additional applications may be predicted by calculating using models generated as described above, without necessarily having to annotate the raw data.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for maintaining a client device, the method comprising:
monitoring, by an application monitoring engine, application health data of applications installed on the client device, the application health data defining at least one application property for each of the installed applications;
detecting, by a predictive maintenance engine, a predetermined condition from the at least one application property based on monitor rules;
in response to the detecting of the predetermined condition, generating a predictive maintenance action.

2. The method of claim 1, wherein predictive maintenance engine is run on a server remote from the client device.

3. The method of claim 1, wherein the predictive maintenance engine is run by the client device.

4. The method of claim 3, wherein the monitor rules are received from a server.

5. The method of claim 4, further comprising receiving, from the server, updated monitor rules for detecting the predetermined condition, the updated monitor rules generated based on the log data.

6. The method of claim 2, further comprising:
detecting an anomaly associated with an operation of one of the installed applications; and
sending an anomaly report to the server, the anomaly report comprising the at least one application property of the anomalous application.

7. The method of claim 5, further comprising:
receiving, from the server, updated monitor rules for detecting the predetermined condition based on the anomaly report.

8. The method of claim 1, wherein the at least one application property comprises:
application install date;
application version;
application installation path;
application executable file size;
resource usage data;
application registry information;
active processes; or
a combination thereof.

9. The method of claim 7, wherein the at least one application property comprises:
application install date;
application version;
application installation path; and
application executable file size.

10. The method of claim 1, wherein the monitor rules comprise determining, for each of the installed applications:
an application relative install date score;
an application version health score;
an application installation path score;
an average age of all of the installed applications on the client device score;
a total number of the installed applications on the client device score;
an application executable file size score; or
a combination thereof.

11. A client device comprising:
a processor, and
a memory comprising:
at least one application installed on the client device, and
executable instructions stored thereon, that when executed cause the device to:
monitor application health data of the at least one application, the application health data defining at least one application property for each of the at least one application;
detect a predetermined condition using at least one application property for each of the at least one application based on monitor rules; and
in response to the detection of the predetermined condition, generate a predictive maintenance recommendation.

12. A system for predictively maintaining a client device, the system comprising:
a client device comprising:
a processor; and
a memory comprising:
at least one application installed on the client device;
executable instructions stored thereon, that when executed cause the device to:
monitor application health data of the at least one application, the application health data defining at least one application property for each of the at least one application; and
transmit the application health data in response; and
a server in communication with the client device, the server comprising:
a processor;
a memory comprising:
executable instructions stored thereon, that when executed cause the server to:
receive application health data of the at least one application from the client device;
detect a predetermined condition using the at least one application property for each of the at least one application based on monitor rules; and
generate a predictive maintenance recommendation describing the predetermined condition and one or more actions.
